(19) United States
(12) Patent Application Publication
(10) Pub. No.: US 2020/0193426 A1
(43) Pub. Date: Jun. 18, 2020

(54) METHOD AND SYSTEM FOR CREATING AND UPDATING AN AUTHENTIC LOG FILE FOR A COMPUTER SYSTEM AND TRANSACTIONS

(71) Applicant: Secude AG, Lucerne (CH)

(72) Inventors: Heiner Kromer, Emmetten (CH); Philipp Meier, Lucerne (CH); David William Reber, Lucerne (CH)

(21) Appl. No.: 16/717,512

(22) Filed: Dec. 17, 2019

Related U.S. Application Data
(60) Provisional application No. 62/781,116, filed on Dec. 18, 2018.
(60) Provisional application No. 62/818,166, filed on Mar. 14, 2019.
(60) Provisional application No. 62/829,880, filed on Apr. 5, 2019.
(60) Provisional application No. 62/860,373, filed on Jun. 12, 2019.

(51) Int. Cl. G06Q 20/38; G06F 16/17; H04L 9/06; G06F 11/14

(52) U.S. Cl. CPC G06Q 20/389; G06F 16/1734; H04L 2209/38; G06F 11/1458; G06F 11/1448; H04L 9/0643

(57) ABSTRACT

The present invention relates to a method and system for storing log data entries to provide a for a nonrepudiation log file that may be authenticated on an entry by entry basis. The system and method may be, or use, an encoder plug-in to translate entries into paired data and to write the translated entry to the log file in any order thereby allowing for the use of multiple processor systems. The log entries may be extracted and verified as authentic using this encoding plug-in and one or more processor systems. Various techniques may be used to prevent tampering with the log to remove a tuple and to detect unauthorized removal of data from the log. The present invention also relates to a method and system of securing and processing digital asset transactions.

### CROSS-REFERENCE TO RELATED APPLICATIONS

The present application claims benefit of and priority to Provisional Patent Application No. 62/781,116 filed Dec. 18, 2018 entitled METHOD AND SYSTEM FOR CREATING AND UPDATING AN AUTHENTIC LOG FILE FOR A COMPUTER SYSTEM; U.S. Provisional Patent Application No. 62/818,166 filed Mar. 14, 2019 entitled METHOD AND SYSTEM FOR CREATING AND UPDATING AN AUTHENTIC LOG FILE FOR A COMPUTER SYSTEM; U.S. Provisional Patent Application No. 62/829,880 filed Apr. 5, 2019 entitled METHOD AND SYSTEM FOR CREATING AND UPDATING AN AUTHENTIC LOG FILE FOR A COMPUTER SYSTEM AND METHOD AND SYSTEM FOR SECURING AND PROCESSING DIGITAL ASSET TRANSACTIONS and U.S. Provisional Patent Application No. 62/860,373 filed Jun. 12, 2019 entitled METHOD AND SYSTEM FOR CREATING AND UPDATING AN AUTHENTIC LOG FILE FOR A COMPUTER SYSTEM AND METHOD AND SYSTEM FOR SECURING AND PROCESSING DIGITAL ASSET TRANSACTIONS, the entire content of each of which is hereby incorporated by reference herein.

### BACKGROUND

### Field of the Disclosure

The present disclosure relates to securing a log file in a computer system. More particularly, the present disclosure relates to a system and method for creating and updating a computer log that allows for authentication of each log file entry and allows information to remain confidential. The present disclosure also relates to a method and system of securing and processing digital asset transaction records.

### Related Art

In a computer system, a log file is a repository for log information associated with events that occur on an operating system, service or application. The log information is commonly stored in a log file or similar data storage medium, like a database, for example. Such events may be transactions that may occur for business operations or system events, for example. In general, the log file is used to provide an audit trail of all activity in the computer system. The log file may be digested by a computer system such as generally described in U.S. Pat. No. 7,031,981, to generate a report of selected transactions for business operations and/or submittal for compliance to statutory standards. Conventional log systems have several drawbacks. One drawback is that they do not allow for digesting log files in real time while logging transactions, and at the same time, confirming authenticity and integrity of an entry or entries in the log.

Accordingly, it would be desirable to provide a method and/or system of generating a log file for a computer system that allows for authentication of individual entries in real time and avoids the problems discussed above.

### SUMMARY

It is an object of the present disclosure to provide an efficient method and/or system to create a computer log in which the authenticity of data in each log entry may be confirmed using a plugin encoder. In embodiments, the encoder may be integrated into current environments that write to log files.

Another object of the present disclosure is to provide a system and/or method to enable selection of entries from a log file to authenticate for compliance with such processes as General Protection Regulation (GDPR) such that specific entries may be selected and authenticated. In embodiments, the individual log data entries, or the whole log, may be selectively encrypted. In embodiments, encryption may be accomplished using the Advance Encryption Standard (AES) or a private key for privacy or related use cases. In embodiments, a symmetric key for encryption using AES may be based on a seed, or in a different implementation, uniquely defined per log entry or private key. In embodiments, the symmetric key for encryption may be store in the computer log, however may be encrypted with the public key. In embodiment the symmetric key for encryption may be stored in a storage system or element. In embodiments, the separate storage system or element may simply store the public key encrypted symmetric key and may limit access to the public key to authorized parties. In embodiments, the encrypted text may be provided in a readable format, such as Base58 and the like, in order to provide better readability.

Another object of the present disclosure is to allow for integration into existing systems that write log entries into log files with a limited financial cost of operations as well as maintaining established security processes and protocols.

Another object of the present disclosure is to allow for hiding a notion of related log entries in the log file.

Another object of the present disclosure is to enable multiple processors to write log entries into a log file, independent of order requirements in the construction of an authentic log file as well as to enable the use of multiple processors to validate the log entries.

Another object of the present disclosure is to provide a system and method to secure and process digital asset transactions records that avoid the shortcomings of current blockchain technology.

A method of creating and updating a computer log includes: (a) obtaining, by a log entry computer system, first log data to be added to the computer log; (b) providing, using the log entry computer system, a first seed associated with at least the first log data; (c) generating, by the log entry computer system, a first log entry using the first log data and the first seed; the step of generating the first log entry comprises: i. hashing the first log data and the first seed; ii. combining the hashed first log data and the first seed with the first log data and digitally signing the combined hashed information and first log data to form a tuple; and (d) recording the tuple in the computer log.

In embodiments, the step (c)(i) includes combining the seed and the first log data together and then hashing the combined seed and hashed data.

In embodiments, the first seed is provided based on a source of the first log data.

In embodiments, the first seed is provided based on content of the first log data.

In embodiments, the first seed is stored with the tuple in the computer log.

In embodiments, the first seed is stored in a seed database operably connected to the first log entry computer system.

In embodiments, the computer log is recorded on a read only optical recording medium.

In embodiments, the computer log is recorded on a read only flash drive.

In embodiments, the method may include encrypting at least a portion of the tuple before step (d).

In embodiments, the method includes: e) copying the computer log onto backup recording medium, wherein the backup recording medium is remote from the log entry computer system.

In embodiments the backup recording medium is remote from the log entry computer system.

In embodiments, the method includes: (f) accessing the copied computer log from the backup recording medium; and (g) comparing the computer log to the copied computer log to confirm that the computer log is authentic.

In embodiments the first log data is associated with an event occurring in at least one of the log entry computer system and an external computer system.

In embodiments, the first log data is associated with financial transactions.

A method of authenticating a log entry in a computer log where the log entry is recorded in the form of a plurality of tuples, each of which includes a first portion including a hash of first log data with a first seed and a second portion including the first log data and a digital signature, includes steps of: (a) obtaining, by a reporting computer system, a first seed; (b) extracting, by a reporting computer system, a first tuple of the plurality of tuples from the computer log; (c) separating, by the reporting computer system, the first portion of the first tuple from the second portion of the first tuple; (d) hashing the seed and the second portion of the first tuple; (e) comparing the hashed second portion and seed to the first portion of the tuple to confirm that they match; (f) confirming the digital signature based on a public key; (g) providing an indication that the computer log is authentic when there is a match of the hashed second portion and seed with the first portion and the digital signature is confirmed.

In embodiments, the method includes steps of: (h) extracting, by the reporting computer system, a second tuple of the plurality of tuples from the computer log; (i) separating, by the reporting computer system, the first portion of the second tuple from the second portion of the second tuple; (j) hashing the seed and the second portion of the second tuple using the seed; (k) comparing the hashed second portion and seed to the first portion of the second tuple to confirm that they match; (l) providing an indication that the second tuple is authentic when there is a match; and (m) providing an indication of a relationship between the first tuple and the second tuple based on the seed used to authenticate both the first tuple and the second tuple.

In embodiments, first seed is a seed used to create the first tuple.

In embodiments, the first seed is included in the second portion of the of the tuple.

In embodiments, the first tuple is extracted based on a source of the first log data included on the first tuple.

In embodiments, the first tuple is extracted based on an indicator included in the first potion of the first tuple.

In embodiments, the method is carried out by an encoding plug-in included in the first reporting computer system.

In embodiments, the encoding plug-in is incorporated into the first reporting computer system.

### BRIEF DESCRIPTION OF THE DRAWINGS

Exemplary embodiments of the present invention will be described with references to the accompanying figures, wherein:

FIG. 1 illustrates an exemplary embodiment of encoding element and log entry suitable for use in a log entry system in accordance with an embodiment of the present disclosure;

FIG. 2 illustrates an exemplary block diagram showing combining of log data with seeds to be provided to an encoding element as part of a log entry system in accordance with an embodiment of the present disclosure;

FIG. 3 illustrates an exemplary block diagram illustrating extraction of log entries from a computer log using a log reporting system in accordance with an embodiment of the present disclosure;

FIG. 3A illustrates an exemplary block illustrating interaction between a computer log and a log reporting system in accordance with an embodiment of the present disclosure;

FIG. 3B illustrates an exemplary entry of a computer log created by the log entry system in accordance with an embodiment of the present disclosure;

FIG. 4A illustrates an exemplary block diagram of the multiple processors that may be used to create or authenticate log entries in accordance with an embodiment of the present disclosure;

FIG. 4B illustrates an exemplary computer log including multiple entries provided by the multiple processors of FIG. 4A in accordance with an embodiment of the present disclosure;

FIG. 5A-1 illustrates a detailed view of the log entry system in accordance with an embodiment of the present disclosure in which the encoding element is included is integrated into the log entry device computer system;

FIG. 5A-2 illustrates a detailed view of the log entry system in accordance with another embodiment of the present disclosure in which the encoding element is provided outside of but operably connected to the log entry device computer system;

FIG. 5B-1 illustrates a more detailed view of the log entry system of FIG. 5A-1 in accordance with another embodiment of the present disclosure;

FIG. 5B-2 illustrates a detailed view of the log entry system of FIG. 5A-2 in accordance with another embodiment of the present disclosure;

FIG. 5C-1 illustrates a detailed view of the log entry system of 5A-1 in accordance with another embodiment of the present disclosure;

FIG. 5C-2 illustrates a detailed view of an encryption element of the log entry system used in the system of FIG. 5A-2 in accordance with another embodiment of the present disclosure;

FIG. 5D-1 illustrates a detailed view of the log entry system of FIG. 5A-1 in accordance with another embodiment of the present disclosure;

FIG. 5D-2 illustrates a detailed view of the log entry system of FIG. 5A-2 in accordance with another embodiment of the present disclosure;

FIG. 6 illustrates a flowchart of an exemplary method of generating a computer log in accordance with an embodiment of the present disclosure;

FIG. 7A-1 illustrates a block diagram illustrating interaction between the log entry system and a log reporting system in accordance with an embodiment of the present disclosure;

FIG. 7A-2 is a schematic of a tuple recorded in the computer log using the log entry system and extracted from the computer log using the log reporting system in accordance with an embodiment of the present disclosure;

FIG. 7B illustrates a detailed view of a log reporting system in accordance with an embodiment of the present disclosure;

FIG. 7C illustrates a more detailed view of a log reporting system in accordance with an embodiment of the present disclosure;

FIG. 8 illustrates an exemplary flow chart illustrating a method of authenticating a log entry in accordance with an embodiment of the present disclosure;

FIG. 9A illustrates a detailed view of the interaction between the log entry system of FIG. 5A-2 and the log reporting system in accordance with an embodiment of the present disclosure;

FIG. 9B illustrates a detailed view of the interaction between the log entry system of FIG. 5A-1 and the log reporting system in accordance with an embodiment of the present disclosure;

FIG. 9C illustrates a detailed view of interaction between the log entry system of FIG. 5A-1 and memory elements in accordance with an embodiment of the present disclosure; and

FIG. 9D illustrates a detailed view of interaction between the log entry system of FIG. 5A-2 in accordance with an embodiment of the present disclosure.

### DETAILED DESCRIPTION OF THE EMBODIMENTS

In some applications, authenticity and integrity of data in a computer log or other record may be protected using a digital signature that is based on the underlying log data. Providing a log file, or other record structure, however, is an active process that continually appends data entries. Current digital signature type systems allow a user to authenticate the complete content of the current state of the log or record, but requires the complete data of the log file, even if a user simply wants to prove or authenticate one entry in the log file. Thus, there is a technical problem inherent in these conventional systems in that they do not allow for securing and authenticating individual record entries. This problem has become more of an issue since it is common to outsource computing tasks to cloud providers which may leave customers unaware of changes that these third parties may have made. This lack of security and transparency with respect to records is a serious problem in the context of audits and regulation.

Another conventional option used to ensure accuracy and integrity is a blockchain. In such an embodiment, every entry added to a log file may be added to a blockchain, which is a distributed ledger maintained on a peer to peer network. Using this approach, however, each user of the peer to peer network has the complete blockchain and original data to authenticate each entry. Furthermore, since the blockchain is a peer to peer operation, transactions posted on the blockchain are visible to others, thus presenting a possible issue with respect to security. In addition, use of a blockchain requires multiple users storing the entire blockchain as well as miners that are used for authentication such that the complete blockchain and all data recorded therein is present on multiple computing systems, which raises an increased risk of security breaches and increases costs as well as processing time. Thus, conventional blockchain record systems suffer from inherent technical problems in that all participants are provided access to the entire record which eliminates confidentiality as well as fact that the blockchain inherently raises both use costs and processing time as the record grows.

As a subset of the blockchain approach, a Merkle tree may be used to construct a log file that allows for authentication of data. The Merkle tree, however, also has limitations with respect to deletions of entries that depend on each other, performance issues and the requirement of controlling ordering while appending entries. Thus, there is an inherent technical problem with Merkle tree systems in that they similarly don't allow for authentication of individual entries in the record.

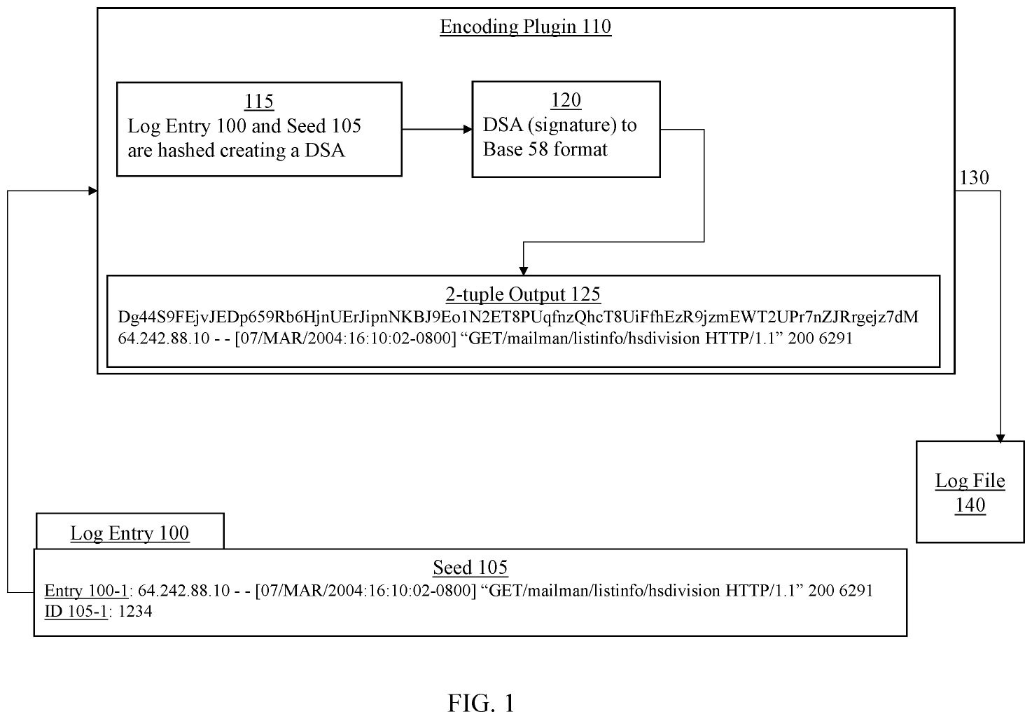

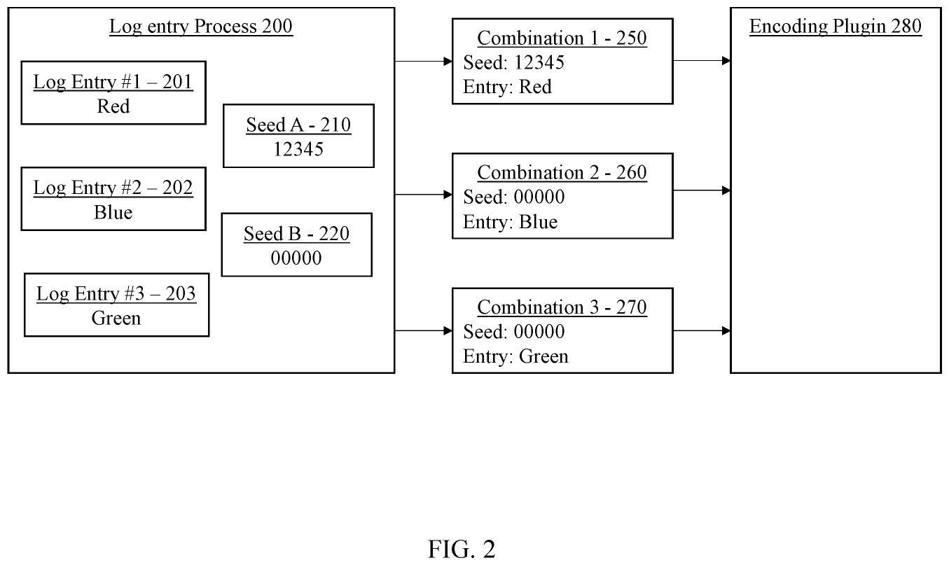

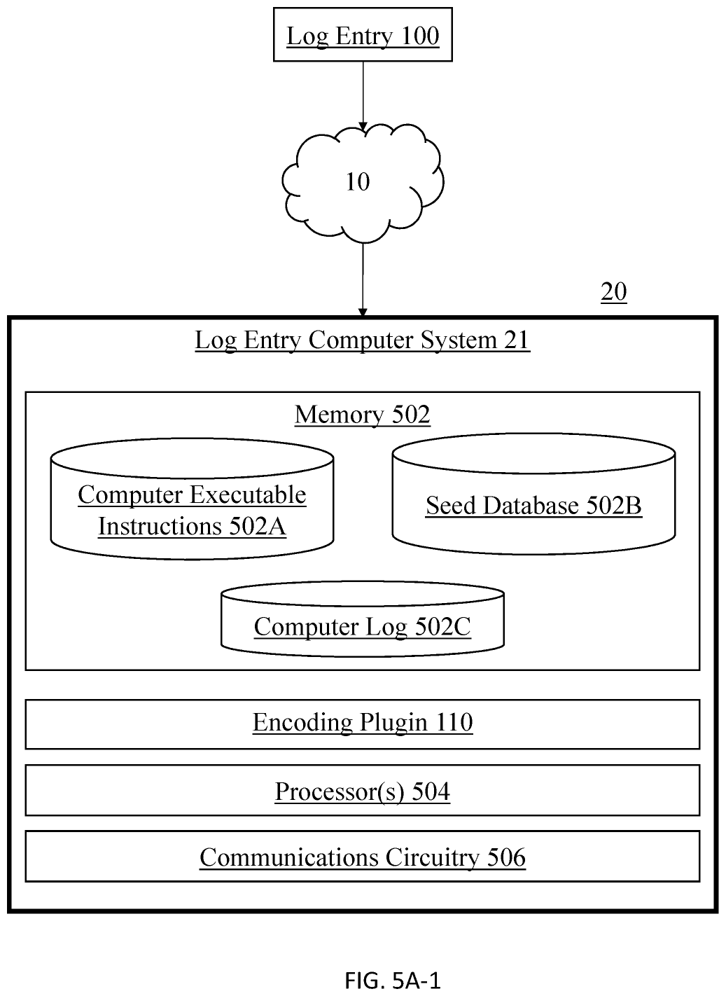

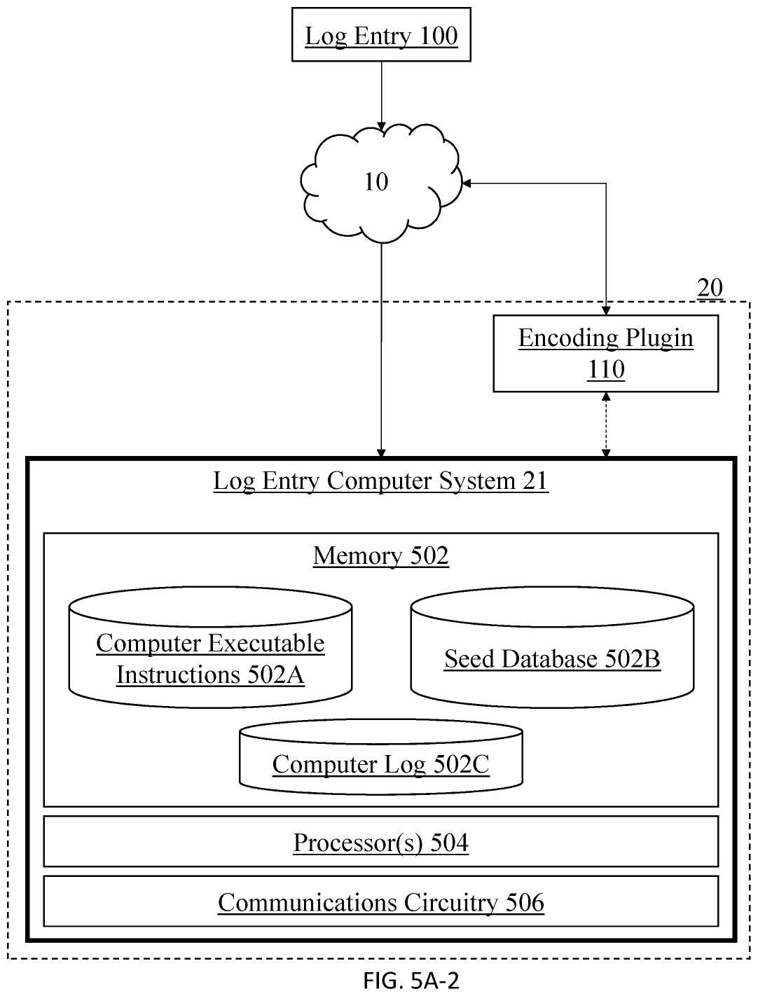

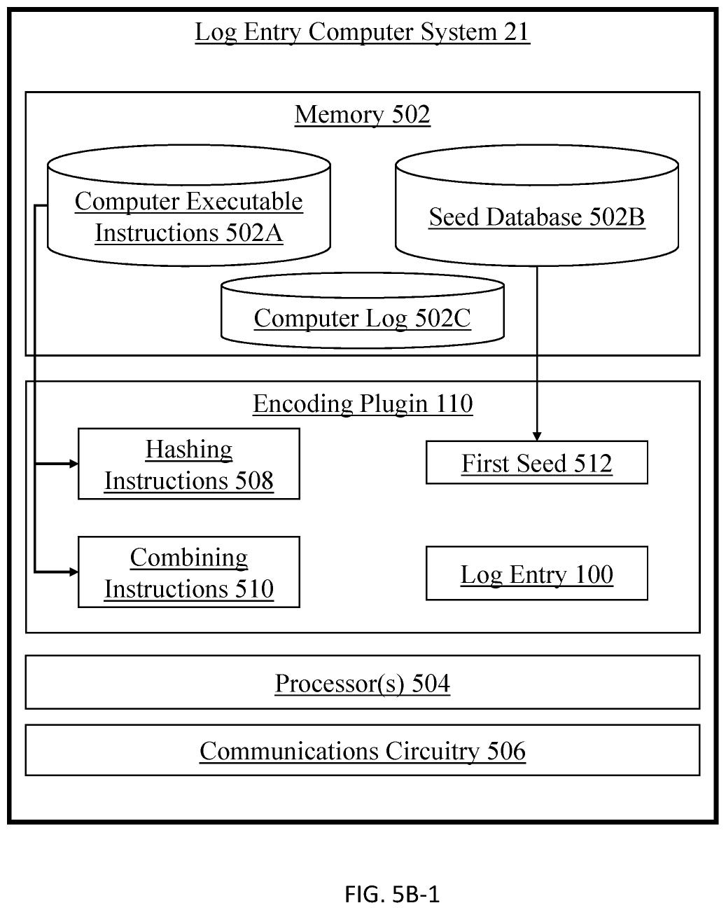

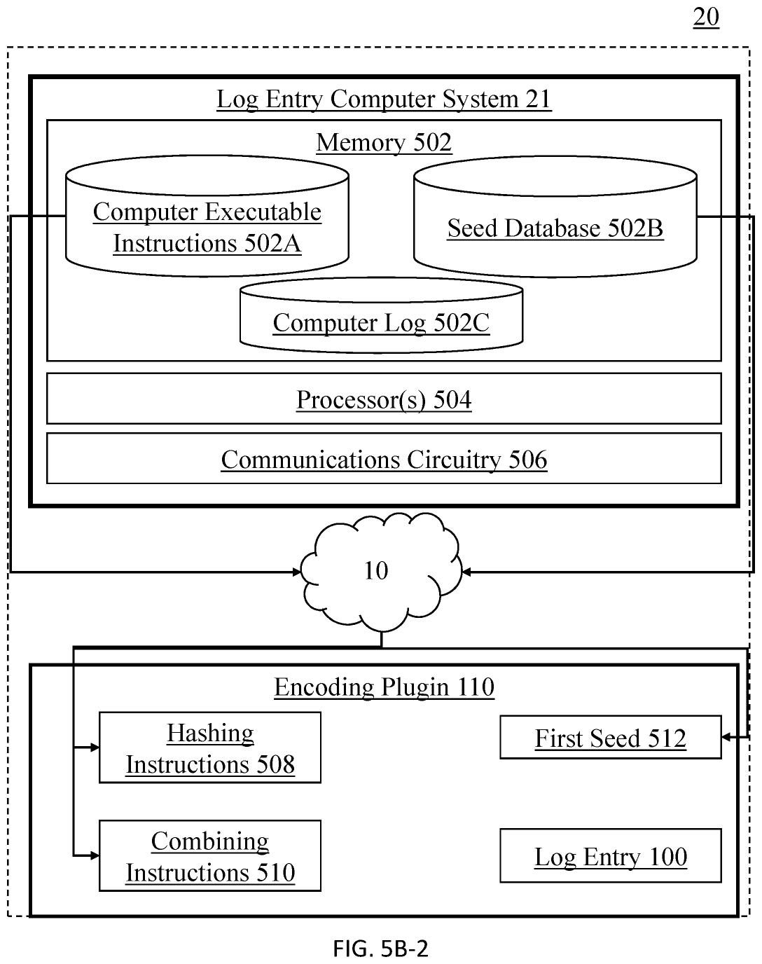

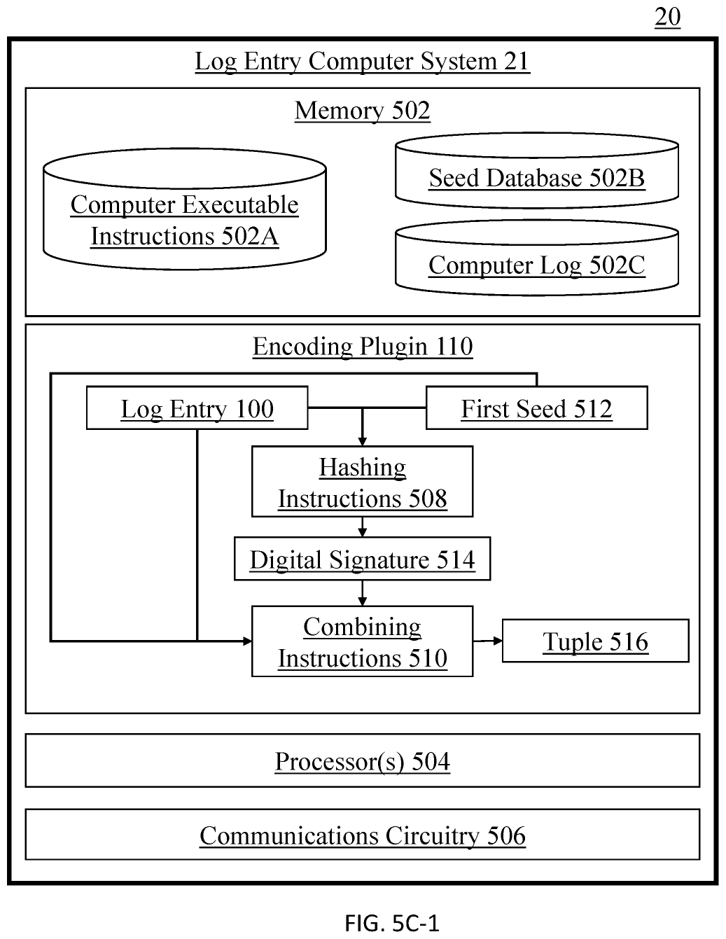

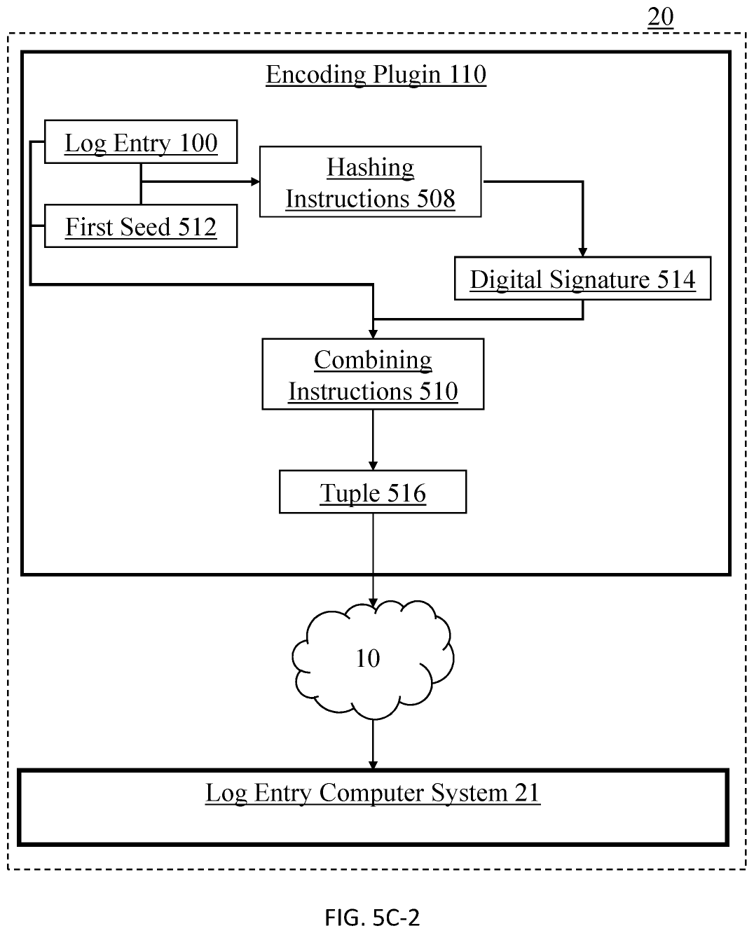

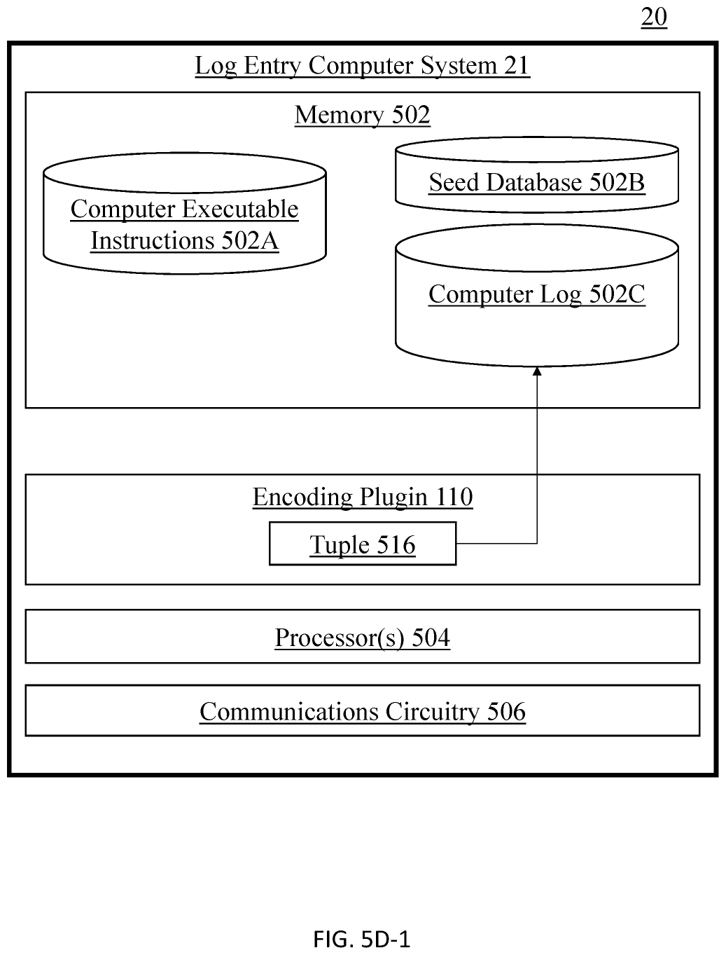

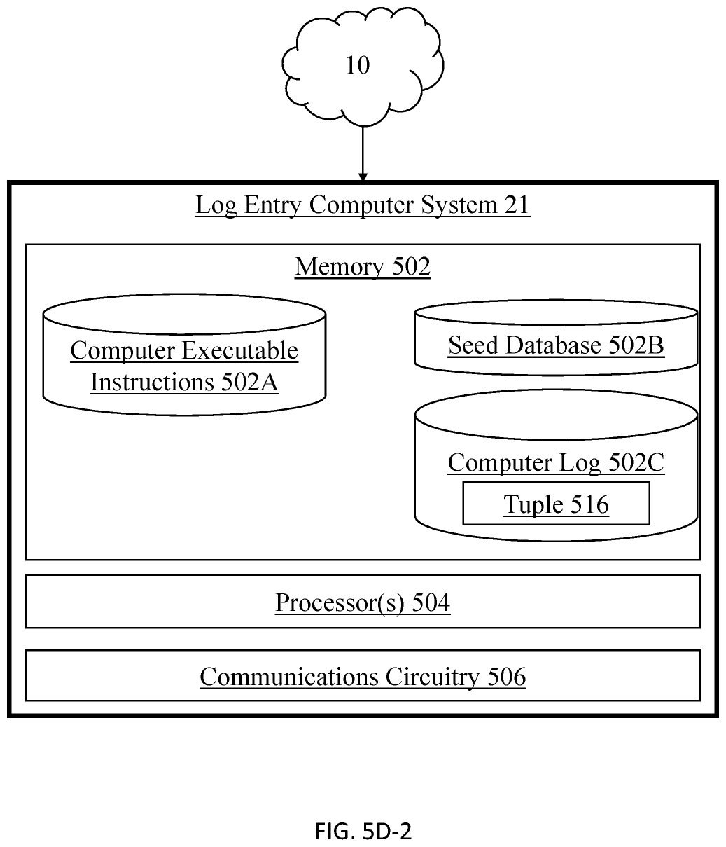

In embodiments, referring to FIG. 1, for example, a log entry or log data 100 is shown that is to be written to a log file 140 using the system and method of the present application. In embodiments, the log entry data and a seed 105, together referenced as 115, may be sent processed by an encoding element or plug-in 110 that is part of or connected to a log entry computer system 21 (see FIG. 5A-1, for example). In embodiments, the encoding element (or plug-in) 110 may operatively be connected to the log entry computer system 21 as part of the log entry system 20 (See FIG. 5A-2). In accordance with an embodiment of the present disclosure, the encoding element or plug-in 110 may hash the seed and log entry data as indicated at 115. In embodiments, the hash may be based on the Secure Hash Algorithm-256 (SHA-256) or any suitable strong hashing method. In embodiments, hashing instructions consistent with the selected hashing algorithm may be provided or stored in the encoding element 110, or in the log entry computer system 21. In embodiments, combining instructions 510 may be provided in the encoding element 110, or in the log entry computer system 21 and executed to combine hashed portion of the tuple with the log data (log entry 100). In embodiments, the seed and the log data may be string copied together and the resulting string may then be hashed. In embodiments, a special symbol may be positioned between the seed and the log data. In embodiments, the seed and log data may be combined in a binary form with the entire result hashed. In embodiments, the seed and the log data may be hashed separately and then copied together. The combined hashed seed and log data may then be signed. In embodiments, a special symbol may separate the seed and the log data. In embodiments, the combined hashed seed and log data may be hashed again and then signed. In embodiments, the hashed seed and data entry may be signed with a digital signature 514 (see FIG. 5C-1, for example) which may be provided or generated in the encoding element 110 or the computer 21 based on a private key which corresponds to a public key. The digital signature may be converted to a readable format, such as Base58, for example, as indicated at 120. In embodiments, the digital signature may be converted to another readable format. In embodiments, the digital signature may not be converted for readability. In embodiments, the digital signature may be paired with the log entry data in the “tuple” as indicated at 125. As used herein, the term “tuple” refers to a pairing of a digital signature including hashed information with a log entry. In embodiments, the tuple may then be written into the log file 140. While the term log file is used, it is noted that the log file 140 is not limited to a file but may be any memory element that stores log entries. This may be done via the encoding element or plug-in 110, the log entry computer system 21 or via another computer system operatively connected thereto.

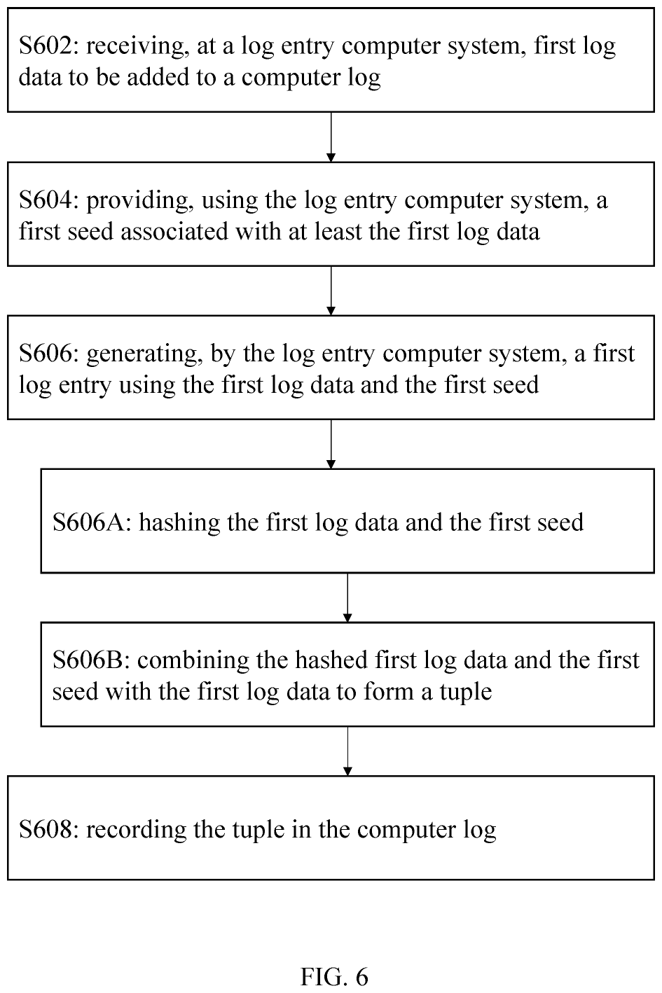

In embodiments, the log entry system 20 may include the log entry computer system 21. In embodiments, the log entry computer system 21 may include the encoding device or plug-in 110 as in FIG. 5A-1. In embodiments, the encoding device 110 may be operably connected to the log entry computer system 101 as in FIG. 5A-2. The log entry system 20 may also include one or more memory elements or databases. In embodiments, an instruction database 502A may include executable instructions that maybe executed by one or more processors 504 of the computer system 21 to execute steps the create and update the computer log 140. In embodiments, these instructions may result in the processor executing the steps of FIG. 6, for example. A seed database 502B may be provided and include a plurality of seed for use in creating log entries. In embodiments, the computer log 140 may be stored in a computer log database 502C. In embodiments, the computer log 140 may be stored in an external memory or database operably connected to the computer 21. In embodiments, log data for a log entry 100 may be provided via a communications network or bus 10 from one or more systems or applications operably connected to the log entry computer system 21. In embodiments, the computer 21 may include communications circuitry 506 to allow for communication via the network or bus 10 or any other suitable communication system.

Referring to FIG. 2, the log entries write log entries to a log file is shown. In embodiments, the log entry system 20 may be implemented in or with an encoding element (or plug-in) 110 as discussed above. In embodiments, computer executable instructions may be provided in memory 502A to the one or more processors 504, that when executed by the processors perform the functions of the log entry system 20 and/or the encoding element 110. In embodiments, three log entries: text “red” 201, text “blue” 202, and text “green” 203 are illustrated. In embodiments, the log entry computer system 21 included in the log entry system 20 may create two unique seeds 210 and 220. In embodiments, the log entry computer system 21 may send the seed 210 with the entry log data text “red” 201 (as indicated by 250) to an encoding element 110 (which may be implemented by the encoding plug-in) to provide an entry in the log based on the log data and seed. In embodiments, the encoding element 110 may be included in the log entry computer system 21. In embodiments, the encoding element may be operatively connected to the log entry computer system 21. In embodiments, the log entry computer system 21 may send the seed 220 with the entry log data text “blue” 202 (as indicated by 260) to the encoding element 110 to write another entry for that log data. The log entry computer system 21 may send the seed 220 with the entry log data, the text “green” 203 (as indicated by 260) to the encoding element 110 to provide an entry for that data. That is, in embodiments, the seed discussed above with respect to FIG. 1 may be provided by the log entry computer system 21 for use by the encoding element 110. In embodiments, the seed may be used to create a relationship between elements in the tuple. In embodiments, a party who has the seed, or access to the seed, may use it to confirm the relationship between the data in the tuples by rehashing the log data with the seed. If the result is the same as included in the tuple, then the elements are properly matched and there has been no manipulation of the tuple. Similarly, log entries or tuples that use the same seed for creation may be related to each other.

FIG. 6 illustrates an exemplary flow chart illustrating a method for entering a log entry into a computer log. In embodiments, at step S602, the log entry computer system 21 obtains first log entry data. The first log entry data may be indicative of an event or occurrent in the log entry computer 21 or may be received from another computer system or another application. At step S604, in embodiments, a first seed is provided. In embodiments, step S604 may come before step S602. In embodiments, the first seed may be selected or generated by the log entry computer system 21. In embodiments, the first seed may be obtained from a storage element include in or operatively connected to the log entry computer system 21. In embodiments, the first seed may be selected based on the content of source of the first log information. In embodiments, in step S 606, the log entry computer system 20 generates a first log entry based on the first log entry and the first seed. In particular, in embodiments, the first log data and the first seed may be hashed in step S606A and the result combined to the first log data and digitally signed in step S606B. The resulting tuple including the two parts is then recorded in a computer log in step S608. In embodiments, step S606 may be performed by encoding member 110 which may be integrated into the computer system 21 or separate and operatively connected thereto. In embodiments, the tuple may be signed with an electronic signature based on a private key.

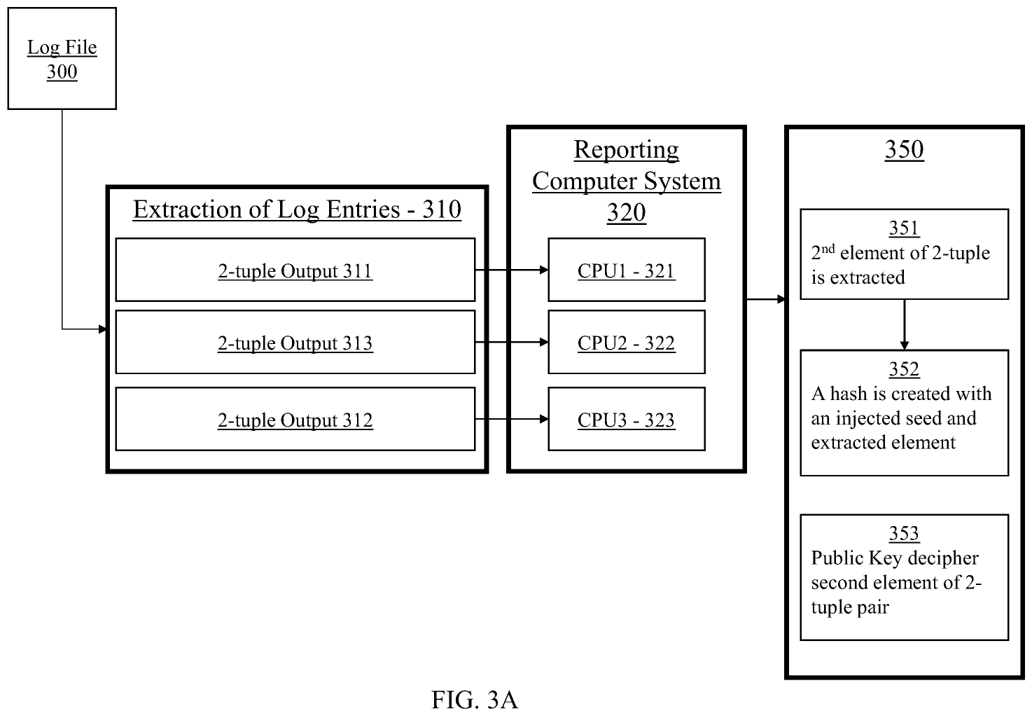

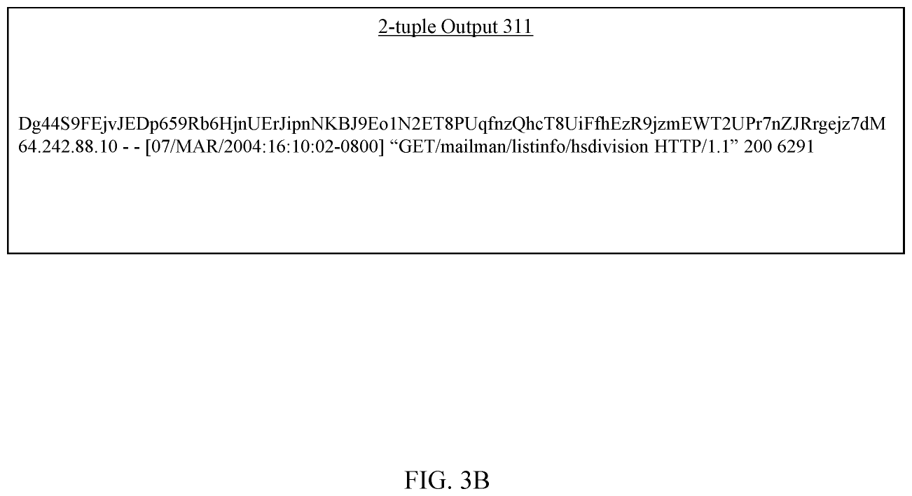

FIG. 3 illustrates exemplary extraction of log entries from a computer log 140. As illustrated, the log entries 311, 312, 313 in a log file 300 are provided as tuples. The log file 300 may be the computer log 140 or another computer log. In embodiments, one or more log entries may be extracted from the log file and authenticated. In embodiments, the three log entries 311, 312, and 313 may be extracted from the log file 300 for authentication. In embodiments, such extraction may be performed by or at the direction of a reporting application implemented on the log entry computer system 21 or a reporting computer system 320. In embodiments, the reporting computer system 320 may be provided with or separate from the log entry computer system 21. In embodiments, extractions of log entries may be based on a context of each entry, such as a date or IP address for filtering entries of interest. In embodiments, each log entry may be formatted as a tuple as noted above. In embodiments, authenticating the log entries may use parallel processing. In embodiments, each log entry may be sent to a different processing unit 321, 322, 323 of the reporting computer system 320 to provide for parallel processing to authenticate each log entry. In embodiments, a cluster of computers may be used to implement the reporting computer system 320 which may include the processing units 321, 322, 323, as well as others, if desired. In embodiments, rather than a cluster of computers, a multi-core processor may be used.

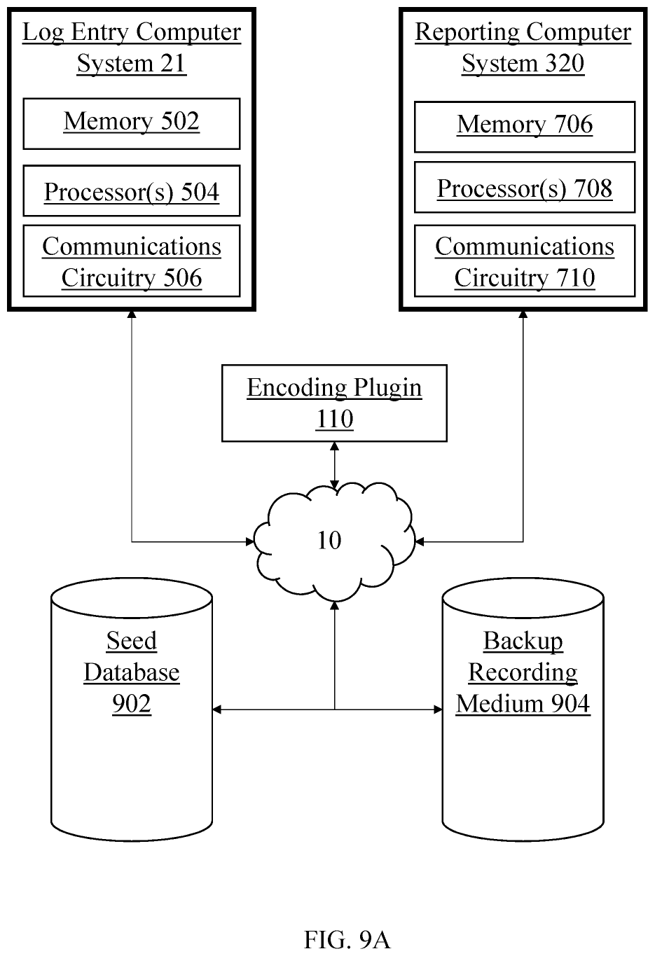

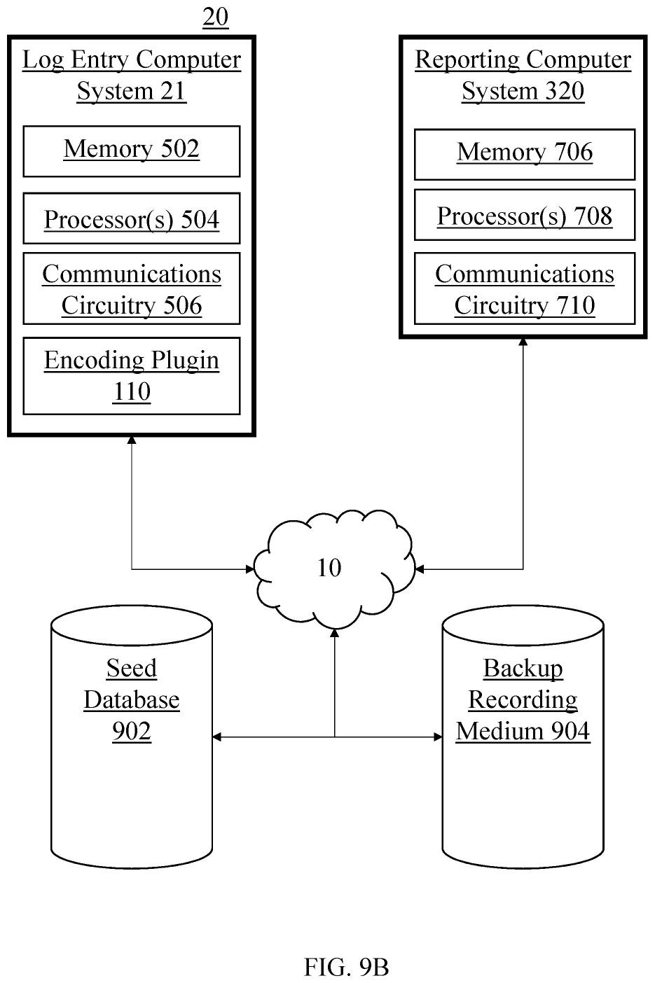

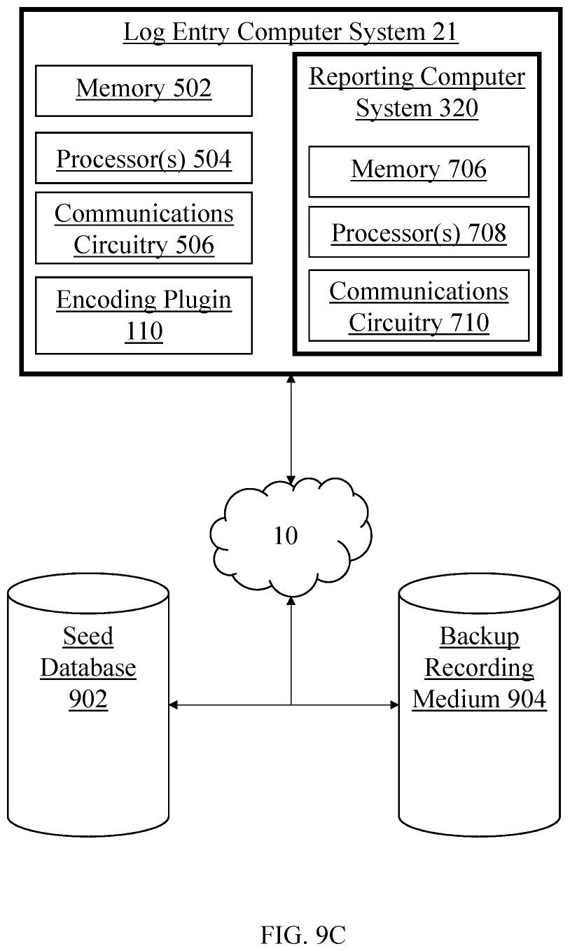

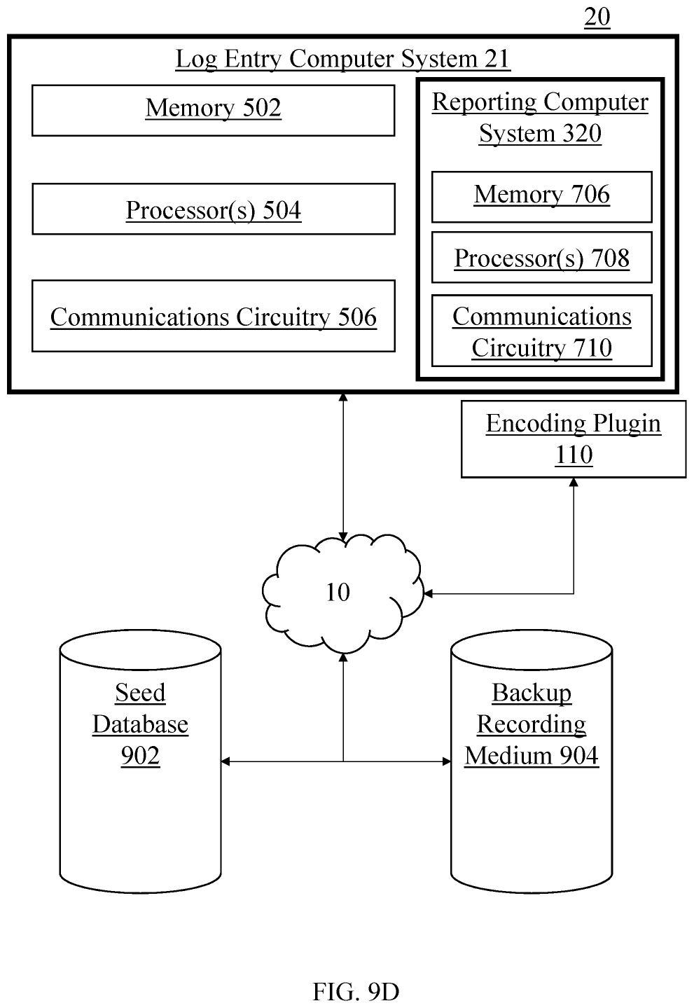

In embodiments, the log entry 311 may be processed for nonrepudiation (authenticity) using processor 321. In particular, as indicated at 350, each processor 321, 322, 323 may extract the second element of the tuple that makes up each log entry and a Hash 352 may be created with an injected seed. In embodiments, this seed may be obtained from a database based on criteria of the log entry data or may be included with the tuple that is extracted. In embodiments, the seed may be used as a system identifier, that is, identifying the system that made the log entry. In embodiments, the seed may be used as a user identifier associate with a user of the system that made the log entry. In embodiments, the seed may be used to establish other relationships between tuples in the computer log and certain environments. In embodiments, the seed may be related to business process ideas. In embodiments, the seed may be retrieved from one or more databases such as database 502B discussed above or the seed database 902 illustrated in FIG. 9A for example. In embodiments the seed may be obtained from an external storage system or another secure storage system. In embodiments, hashing may be used to show that the first element of the tuple, including the digital signature, was derived from the second element of the tuple (the log data) for proof of the authenticity of the log entry (nonrepudiation) using a public key 353 corresponding to the key used to provide the digital signature. In embodiments, the public key may be provided to multiple processing systems, such as the processors 321, 322, 323. In embodiments, log entries 250, 260, 270 of FIG. 2 may correspond to the log entries 311, 312, and 313 extracted in FIG. 3. In an example, given the seed 00000 shown in FIG. 2 the processing results for each processing unit 321, 322, 323 processing in accordance with 350 using the seed would produce a nonrepudiation set, i.e. a set of three authenticated log entries. FIG. 3B illustrates an example of an extracted tuple.

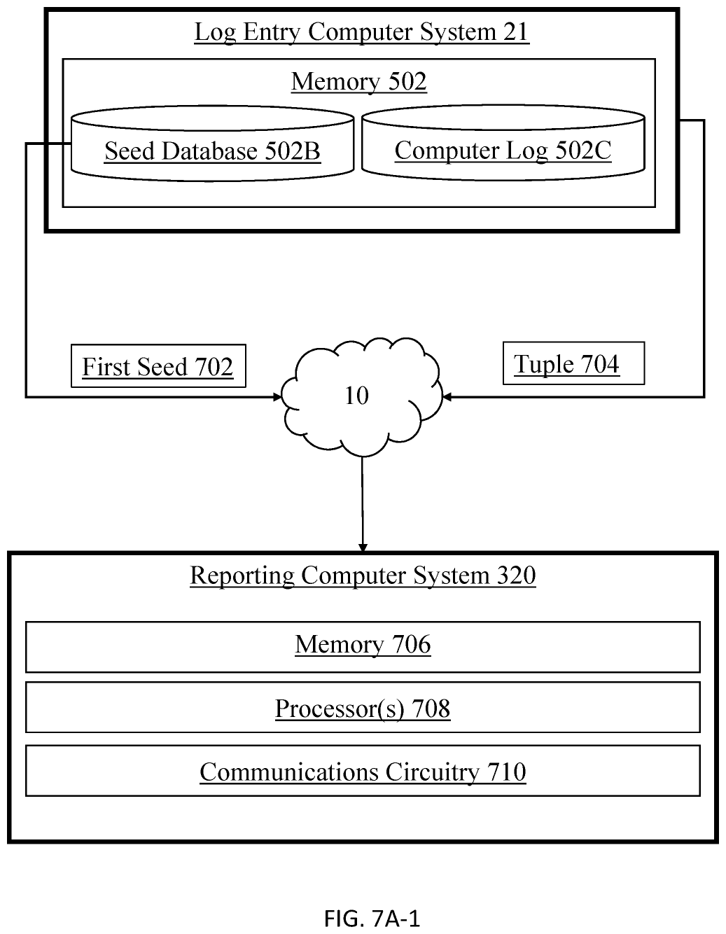

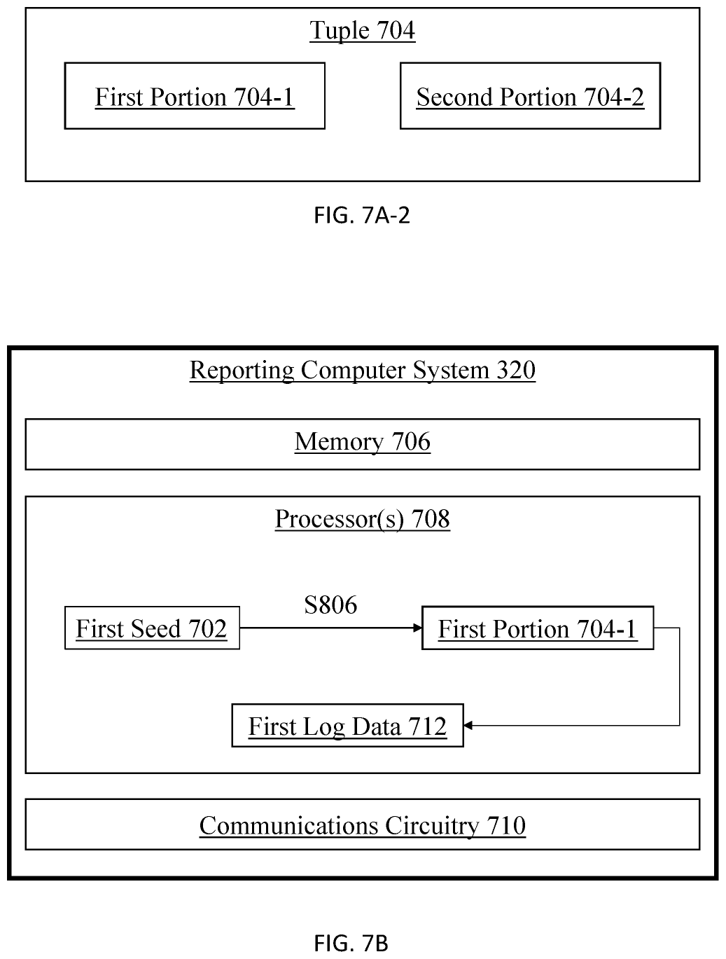

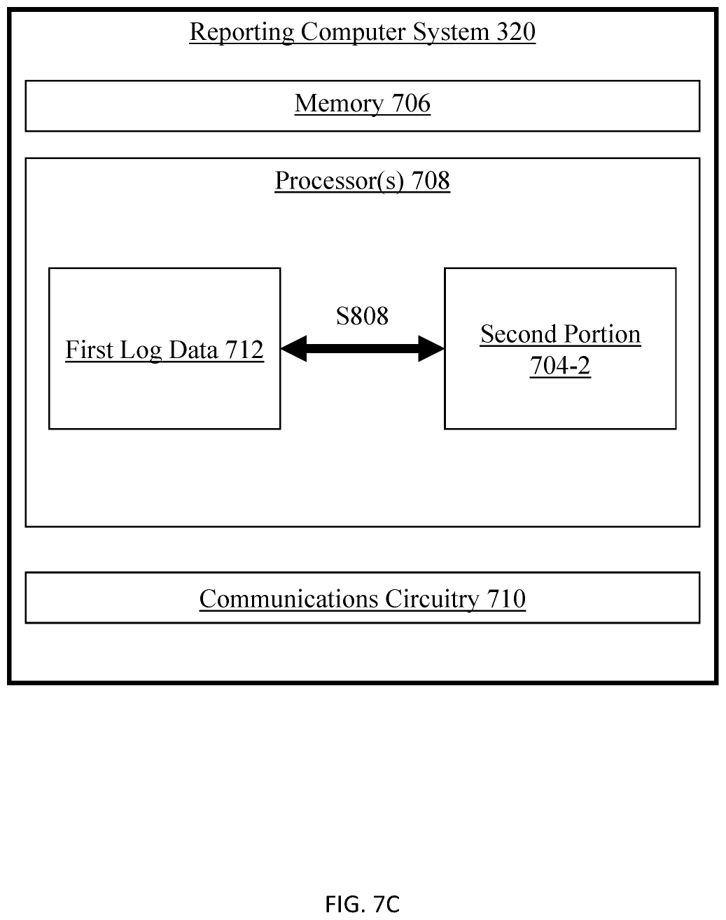

In embodiments, log entries, or tuples 311, may be extracted and authenticated by a reporting computer system 320. In embodiments the extracted tuples 311 are processed, preferably parallel processed as noted above with respect to FIG. 3. In embodiments, the reporting computer system may include one or more processors 708 as can be seen in FIG. 7C, or processors 321, 322, 323 shown in FIG. 3A. The tuples are processed to separate the second element, the log data separated from the first. The public key corresponding to the private key used in the private signature is used to decipher the second portion of the tuple after it is separated. Then the second portion is hashed using the same seed as when logged. The result is then compared to the first part to see if it matches. If there is a match, the tuple is authenticated as the log data has not been modified. The seed used in the reporting computer 320 may be provided from the database 502B of the log entry computer system 21 or seed database 902 as can be seen in FIG. 9A, for example.

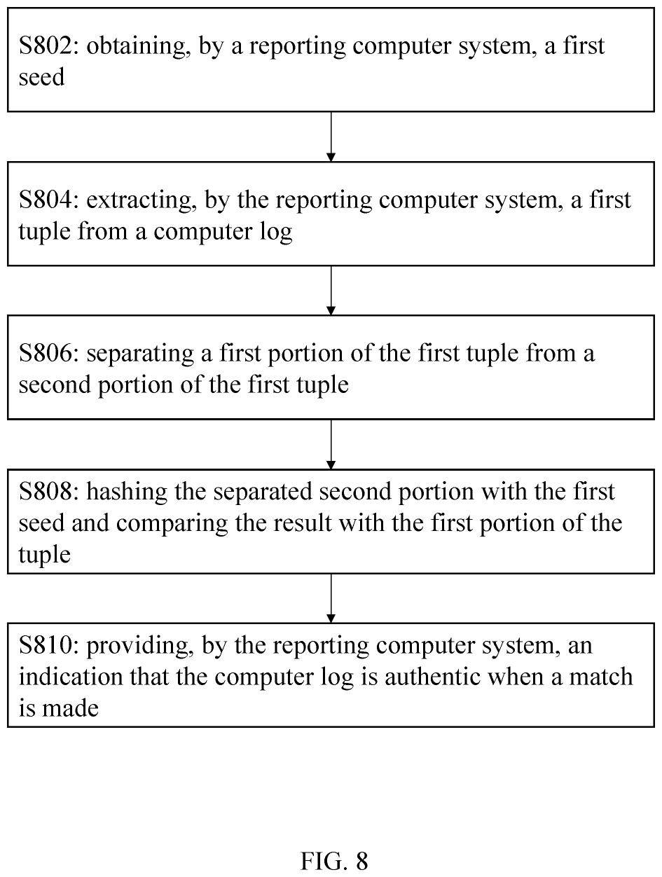

FIG. 8 illustrates an exemplary flow chart of a method of extracting and authenticating individual tuplets, or log entries. In embodiments, the steps of FIG. 8 may be implemented by the reporting computer system 320, a reporting application implemented by the log entry computer system 21 or the encoding element 110. At step S802, a first seed may be obtained, by the reporting computer system 320 for example. In embodiments, this see may be the same as the first seed used in FIG. 6. At step S804, at least one log entry is extracted from the computer log by the reporting computer system 320. In embodiments, at step S806 the two portions of the log entry are separated to isolate second portion including the log data. The log data is hashed with the seed and the result is compared to the first portion of the tuple to see if they match at steps S808-S809. If there is a match, the authenticity of the tuplet is confirmed and an indication of a match is provided at step S810. If there is no match, this may indicate that the log has been modified and there will be no notice of authenticity. In embodiments, a digital signature associated with the extracted tuple is confirmed base on a public key. In embodiments, the public key is retrieved from a memory or may be received and stored for future use. Confirming the digital signature confirms the log entry has not been tampered with since it was entered with the digital signature. If the signature is not confirmed, this may indicate manipulation of the tuple. In embodiments, an indication of no match or a warning regarding manipulation may be generated and indicated to a user or administrator.

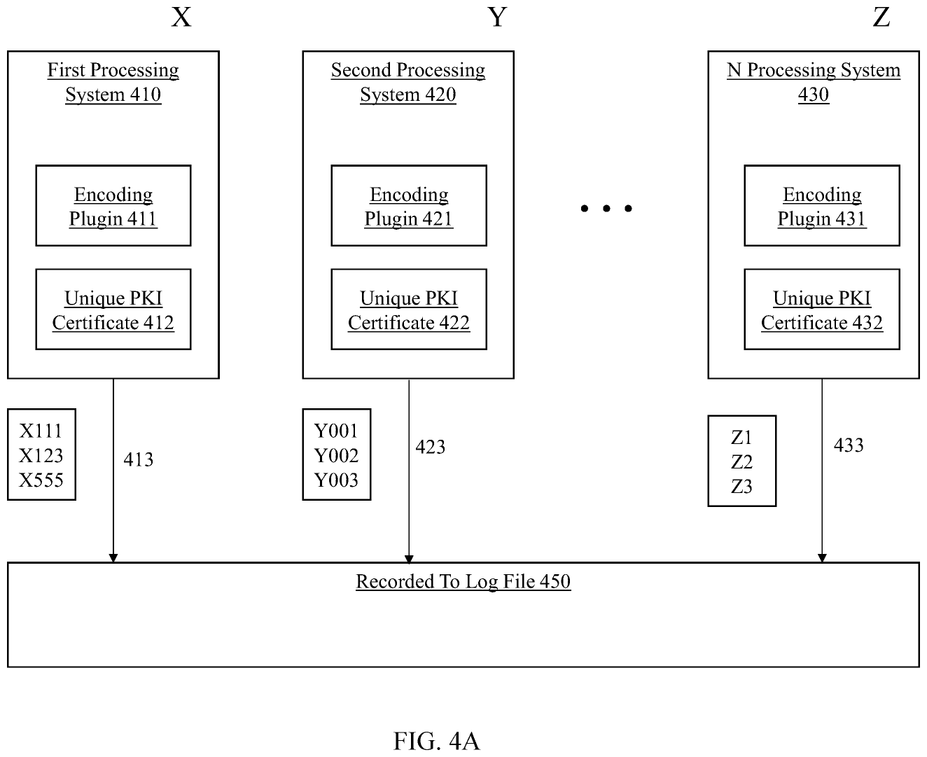

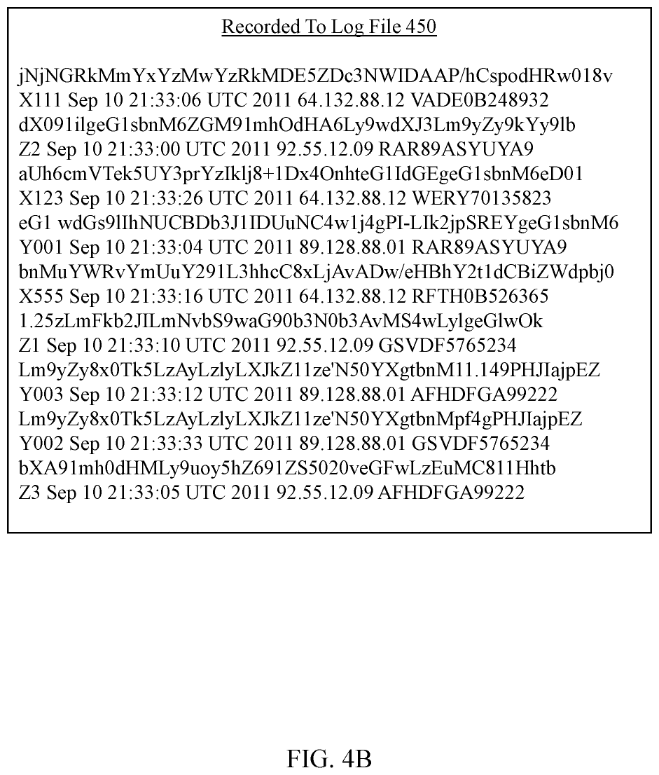

In FIG. 4, computer systems 410, 420, 430 may be provided to perform transaction processing. In embodiments, a transaction computer system 410 may use an encoding element (or plug-in) 411 (or 110) and a unique public key infrastructure (PKI) to provide a digital signature 412 for the encoding element to use. In embodiments, the encoding element 110 may be or may include or be included in a computer or other processor. In embodiments, the encoding element 411 may be the element 110. In embodiments, the computer system 420 may use the encoding element and a second unique PKI for a digital signature 422, the computer system 430 may use the encoding element or plug-in 431 and a third unique PKI for a digital signature for the encoding plug-in to use. The plug-in may be similar to encoding plug-in 110. In embodiments, three transactions of system 410, indicated by 413, may be recorded to log file 450. In embodiments, the three transactions of system 420, indicated by 423, may be recorded to log file 450. In embodiments, the three transactions of system 430, indicated by 433, may be recorded to log file 450 such that the log file has interlaced log entries in the form of tuples. In embodiments, the log file may include tuples from more than one system. In embodiments, tuples from different systems may use different hash algorithms and different keys. In embodiments, transactions for computer system 410 may be extracted based on the fact that the tuple begins with X and may be authenticated using the known derived seed for the corresponding digital signature of the tuples used by the computer system 410. In embodiments, the identifying feature, such as the X, may be used to determine the hash algorithm and/or key used to create the tuple.

In embodiments, where the encoding member 110 is a part of the log entry computer system 21, as can be seen in FIG. 5B-1 a first seed 512 may be provided to the encoding member which combines it with the log data (log entry 100) with result being hashed and then the hashed result combined with log data to provide the tuple which is recorded in the computer log 140. In embodiments, where the encoding element 110 is provided outside the computer system 21, the seed is transmitted to the element 110 and the tuple is made in a similar manner as can be seen with reference to FIG. 5B-2.

In embodiments, a tuple 311 may be embodied by two separate information sections or elements 311-1, 311,312 as noted above and illustrated in FIG. 7A-2. In embodiments, the initial, or first element, is a seed and the log information combined and hashed using a modern hash algorithm. In embodiments, this information may then be subsequently signed with a private key corresponding to the private key used to provide the digital signature. In embodiments, the digital signature and the log information may be stored together in a log storage medium such as a log file or database.

In embodiments, the seed used in conjunction with the original log data may be stored with the log information or in a different data storage system as discussed above. In embodiments, the seed may be selected randomly or used to group elements together. In embodiments, any party, or computer system with the seed, or access to the seed, may validate individual tuples in the computer log that belong to the same seed group. In embodiments, parties are thus able to validate individual log entries without the need to store or access or process the entire computer log. In embodiments, the seed may be thought of as a continuous numbering schema to validate belonging elements.

In embodiments, the seed may be a combination of log elements. In embodiments, a calculation using the log elements may be used to generate the seed.

In embodiments, the seed may be used to symmetrically encrypt elements in the log to hide, or disguise, data elements that are of a confidential nature. In embodiments, hashing may take place before or after encryption. In embodiments, hashing may take place after encryption. In this case, even is the party does not have access to the original data, they may authenticate the tuple. In an example, personal identifiable information that is not required to diagnose or work with the log information may be encrypted. In another embodiment, a public key may be used to encrypt all or selective information instead of the symmetric approach. In embodiments, the encrypted information may be made more readable by applying translation in the form of a BASE64, BASE58 or similar encoding algorithm.

In embodiments, the seed may be generated to group together otherwise non-linkable transactional information. In embodiments, the seed may be based on the user or system involved or other information usable to group together log information or a combination thereof.

In embodiments, the public key may utilize public key infrastructure (PKI). In embodiments, different systems may write into the log, each using its own key pair, with trust in between each other so that the different systems validate the signed first element of the tuple entry

In embodiments, to provide protection from removing log elements, one or more copies of each log element may be stored on a different system, or systems. In embodiments, a full copy of the log maybe stored in alternative storage media.

In embodiments, an encoding element may be used by or included in one or more processing computer systems to enable translation of a log entry to a tuple including a first element in the form of a digital signature derived based on a seed and original log entry data, where the original log entry data is a second element of the tuple and the seed is chosen to collect log entries and enable authentication of the log entries to provide a subset of authenticated entries.

In embodiments, the second element of the tuple may include the seed.

In embodiments, the first element of the tuple may include the seed as log entry data stashed into a database for security to hide aspects of set information for log entries that may be filtered for selection of log entries for authentication.

In embodiments, one or more tuples may be selected from a written log file to authenticate the tuples using the known derived seed for the digital signature of the tuple pairs.

In embodiments, multiple processors may use the encoding plug-in to write log entries as tuples to a log file in any order to allow for high throughput.

In embodiments, the plug-in may write more than one tuple with different seeds creating a symmetric different set.

In embodiments the first element of the tuple may be based on a symmetric-key algorithm encrypted for security of sampling log entries to prevent public key breaking.

In embodiments, the second element of the tuple may be selectively or completely encrypted. In examples encryption may be used to disguise personal information, for example.

In embodiments, the second element of the tuple may be formatted to be readable text such using Base58, for example.

In embodiments, the tuple may be written to the log file using a formal syntax to provide for extraction of information for third party use applications. In embodiments, the syntax may be JSON, XML, Common Log format or Syslog, to name a few.

In embodiments, multiple processing units may be used to authenticate written log entries extracted from a log file as described above.

In embodiments, a public key may be distributed to parties to independently prove authenticity of the tuple in the log file. In embodiments, the public key may be provided to any party that may be uses to authenticate log entries.

In embodiments, public key infrastructure PKI may be used in the first element of the tuple and may be uniquely defined for each processor that hashes and signs the tuple.

An advantage of the present disclosure is that it is easy to prove whether individual log entries have been manipulated, based on the first element of the tuple t and the public key which is generated by the private key used for signing each tuple.

In embodiments, it is possible to prove that elements belong together without the complete log. In embodiments, only the correct seed will generate the same hash in the first element of the tuple. In embodiments, even if the same key was not used for signing, but rather a seed that is detectably equal, elements in the log entry may still be proofed.

In embodiments, an audit trail may be provided using the above process and system in which the seed may uniquely and transparently identify the person or entity booking each transaction.

In embodiments, complete removal or deletion of a tuple or element thereof, from the log may be identified or flagged in a variety of ways. In embodiments, deletion of a tuple may be prohibited or prevented. In some embodiments, however, the removal of a tuple may not be a concern. In embodiments, for logs of lesser value, general log rotation may be practiced in which case removal of log entries may be common. In embodiments, in systems that has low risk of data manipulation, entry deletion may be permissible.

In embodiments, a write once, read many database or data storage element, typically referred to as a read only memory (ROM) may be used to store the tuples of the log. In embodiments where a ROM is used, specialized hardware fully secures the data in the ROM. In embodiments, the ROM may be an optical disk, for example. In embodiments, the ROM may be a read only flash drive. In embodiments, use of the ROM essentially makes removal of a tuple impossible, without obviously damaging all the data saved on the ROM.

In embodiments, the storage of each tuple may be duplicated on several storage systems or elements. In embodiments, each tuple may be recorded on multiple memory or storage systems or elements such that malicious deletion of a tuple would require access to each and every storage system or element to completely delete the data. In embodiment, multiple storage systems allow for copies of the log to be maintained, which may be compared to each other to detect unauthorized deletion of information and also provide backup and restore capabilities.

In embodiments, an atomic counter count may be embedded in the second element of the tuple, for example. In embodiments, the count may be hashed and processed with the rest of the input, and hence, become immutable. In embodiments, the count may be queried externally or simply embedded as part of the process and data. In embodiments, the embedded atomic counter may be increased whenever a new element is added. In embodiments, an external counter may be a stand-alone device and may be queried each time a new element is added to the log to provide the count that may be included in the second element of the tuple.

In embodiments, a missing or out of place count in a tuple may be used to detect removal of a tuple or other tampering with the log. In embodiments, the missing counter count may be detected based on a comparison to the current counter status. In embodiments, the missing counter count may be detected based on comparison with another version of the log stored on a separate storage system or element.

In embodiments, a hash of the previous log entry may be stored within the two elements of the tuple. In embodiments, this technique may create a continuous chain of tuple elements, with each prior entry linked to the subsequent entry via the hash of the prior entry. In embodiments, rather than hashing the next and/or previous log entry, one or multiple random elements of the log may be hashed and included in the elements of each tuple. In embodiments, hashing one or more random entries in the elements of the tuple provides for removal detection in a non-obvious way. In such embodiments, in order to validate the tuple, the processor or encryption member that authenticates the tuple must know which of the random entries have been selected.

In embodiments, a Merkle tree may be built with different tuple elements, however, this approach is subject to the limitations of Merkle trees discussed above.

In embodiments, a periodic status of the log may be written to an external system to fix the status of the log at that time. In embodiments, a hash of the entire log may be made, either on a regular schedule, randomly or based on occurrence of a trigger event. In embodiments, the trigger to hash the entire log may be based on a total number of entries, for example. In embodiments, the hash of the entire log may be accompanied by a timestamp and signed with the private key. In embodiments, the time stamped hash and signature may be stored on a different system than the log or data storage system. In embodiments, a check for missing information may be performed by comparing a hash of the current state of the log with the externally stored hash of the prior version of the log.

In embodiments, a delete function may be provided to allow for the proper and authorized removal of tuples from the log. In embodiments, this delete function may vary dependent on which of the deletion prevention or detecting techniques generally discussed above are used. In embodiments, the removal of the tuple itself may be a logged event such that a record is made in the log itself of the change. In embodiments, removal of the tuple may require an electronic signature based on an authorized key. In embodiments, the removal process may require multiple steps.

In embodiments, one or more of the deletion protection or detection techniques discussed above may be used together.

In embodiments the method and system of the present application may be used to securely maintain and authenticate events other than those in computer systems and applications. In embodiments, the method and system of the present application may be used to create and secure records in a variety of applications.

In embodiments, the method and system of the present disclosure may be used to provide authenticity, trust and security to records associated with purchasing and selling goods. In embodiments, a participant, or user, may be a person, corporation or other legal entity. Participants may act in the role of buyer or seller. In embodiments, each participant may be checked and authenticated or otherwise vetted before being able to participate in the purchasing and selling of goods. In embodiments, participants may be provided on an invite only basis, and may be required to provide digital copies of official papers or similar credentials. In embodiments, other records or credentials may be required.

In embodiments, log entries indicative of transactions and offers for transactions may be created, stored and authenticated. In embodiments, each and every participant may be issued their own certificate or private key. In embodiments, different levels of cooperation may be established, and a root certificate may be provided. In embodiments, related certificates may have allowance and other requirements associated therewith. In embodiments, dual or multiple signatures may be required to finalize transactions and authenticate records thereof. In embodiments, notifications of sales and purchases may be required to finalize transactions and/or to authenticate records thereof. In embodiments, the certificates may be used to sign and validate different event records. In embodiments, such digital signatures may provide the trust necessary to confirm sales and purchases with supporting records being easy to authenticate. In embodiments, each purchase may be assigned new purchase identification information. The identification information may be similar to information used in existing identification systems to keep compatibility with systems in use today or may be randomly generated and may contain further information. In embodiments, the identification information may be a physical ID found on the product that is being sold. In embodiments, the identification information may be used as the seed. In embodiments, the physical ID may be used as the seed in the tuple used to record the purchase in a record of log. In embodiments, the purchaser's name, product, quantity, price, purchasing ID and other information to identify a purchase may be provided to the seller. In embodiments, the transmission may be signed with the purchaser's certificate or a private key associated with the purchaser. In embodiments the input to the signature may be the data being transmitted (the log data) plus the seed to form a tuplet as discussed above. In embodiments, when the digital signature is added, the seed may be added and signed and countersigned information may be stored in the computer log. In embodiments, the system will create a log of the purchase, or purchase request and send it to the seller. The log entry may be in the form of a tuplet. In embodiments, it may be accompanied by an e-mail notification or the like to one or many participants on the seller side.

In embodiments, after the purchasing request is sent to the seller, the system may validate the purchase request automatically based on the requestor's signature. In embodiments, this may be done in a manner similar to that described above with respect to authenticating individual computer log entries. In embodiments, the receiver may validate the same manually. In embodiment, the seller may accept the purchase request, and may countersign the same request. In embodiments, the seller may not countersign or add any additional information. In embodiments, the counter-signed purchase request may be recorded in a log or other records repository and/or may be sent back to the purchaser. In embodiments, the same approval of a request may be automatically forwarded to a settler or custodian of products involved. In embodiments, specific documents may be generated to facilitate completion of the transaction. Naturally, the information so generated may be stored and logged within the system as well. When the settler participates in the same system, the same procedure may be used to distribute update information and processing of the to be delivered goods or the generated and mutually digitally signed documents will be forwarded. In an example, the settler may sign the counter-signed request as well, and in addition may adjust information to include a settlement processing number, for example. In embodiments, the settler may validate the requests automatically or manually by checking the signatures. In embodiments, these signatures are the signatures used to sign the transaction. In embodiments, the request may include a seed to confirm that the request applies to the same transaction for all parties interested. In embodiments, when the settlement is completed, the settler may sign another element with the required information and forwards to both parties for approval. In embodiments, once countersigned, the signed transaction may be forwarded to a participating custodian. In different embodiments the custodian may sign to conform that money is available, prior to the settler starting transfer of the goods. In embodiments, With the same approach, the custodian may transfer payment to the corresponding party and send a notification to be recorded in the record by the system. In embodiments, both parties then may counter-sign this as well. In embodiments, all transactions may be recorded using the system. In embodiments, collaboration with other 3^{rd} party systems may be desired or legally appropriate. In embodiments, reports may be generated based on the records, for example for the custodian. In embodiments, these records may be combined with the seed, hashed and stored. In embodiments, including the seed makes clear that the records belong to the same transaction.

In embodiments, all elements will be signed and recorded on a storage medium, in different embodiments potentially different mediums may be used. In embodiments, distributed databases, database replication or other storage media may be used to store records of all of these interactions and/or the computer log.

What is claimed is:

1. A method of creating and updating a computer log comprises:
(a) obtaining, by a log entry computer system, first log data to be added to the computer log;
(b) providing, using the log entry computer system, a first seed associated with at least the first log data;
(c) generating, by the log entry computer system, a first log entry using the first log data and the first seed;
the step of generating the first log entry comprises:
i. hashing the first log data and the first seed;
ii. combining the hashed first log data and the first seed with the first log data and digitally signing the combined hashed information and first log data to form a tuple; and
(d) recording the tuple in the computer log.

2. In embodiments, the step (c)(i) comprises:
i. combining the seed and the first log data together and then hashing the combined seed and hashed data.

3. The method of claim 1, wherein the first seed is provided based on a source of the first log data.

4. The method of claim 1, wherein the first seed is provided based on content of the first log data.

5. The method of claim 1, wherein the first seed is stored with the tuple in the computer log.

6. The method of claim 1, wherein the first seed is stored in a seed database operably connected to the first log entry computer system.

7. The method of claim 1, wherein the computer log is recorded on a read only optical recording medium.

8. The method of claim 1, wherein the computer log is recorded on a read only flash drive.

9. The method of claim 1, further comprising encrypting at least a portion of the tuple before step (d).

10. The method of claim 1, further comprising:
(e) copying the computer log onto backup recording medium, wherein the backup recording medium is remote from the log entry computer system.

11. The method of claim 10, further comprising:
(f) accessing the copied computer log from the backup recording medium; and
(g) comparing the computer log to the copied computer log to confirm that the computer log is authentic.

12. The method of claim 1, wherein the first log data is associated with an event occurring in at least one of the log entry computer system and an external computer system.

13. The method of claim 1, wherein the first log data is associated with financial transactions.

14. A method of authenticating a log entry in a computer log where the log entry is recorded in the form of a plurality of tuples, each of which includes a first portion including a hash of first log data with a first seed and a second portion including the first log data and a digital signature, the method comprising steps of:
(a) obtaining, by a reporting computer system, a seed;
(b) extracting, by a reporting computer system, a first tuple of the plurality of tuples from the computer log;
(c) separating, by the reporting computer system, the first portion of the first tuple from the second portion of the first tuple;
(d) hashing the seed and the second portion of the first tuple;
(e) comparing the hashed second portion and seed to the first portion of the tuple to confirm that they match;
(f) confirming the digital signature based on a public key;
(g) providing an indication that the computer log is authentic when there is a match of the hashed second portion and seed with the first portion and the digital signature is confirmed.

15. The method of claim 14 further comprising steps of:
(h) extracting, by the reporting computer system, a second tuple of the plurality of tuples from the computer log;
(i) separating, by the reporting computer system, the first portion of the second tuple from the second portion of the second tuple;
(j) hashing the seed and the second portion of the second tuple using the seed;
(k) comparing the hashed second portion and seed to the first portion of the second tuple to confirm that they match;
(l) providing an indication that the second tuple is authentic when there is a match; and
(m) providing an indication of a relationship between the first tuple and the second tuple based on the seed used to authenticate both the first tuple and the second tuple.

16. The method of claim 14, wherein the first seed is a seed used to create the first tuple.

17. The method of claim 14, wherein the first seed is included in the second portion of the of the tuple.

18. The method of claim 14, wherein the first tuple is extracted based on a source of the first log data included on the first tuple.

19. The method of claim 14, wherein the first tuple is extracted based on a context of the first tuple.

20. The method of claim 14, wherein the method is carried out by an encoding plug-in included in the first reporting computer system.

21. The method of claim 20, wherein the encoding plug-in is incorporated into the first reporting computer system.
